(19) United States
(12) Patent Application Publication
(10) Pub. No.: US 2015/0029051 A1
(43) Pub. Date: Jan. 29, 2015

(54) WEARABLE RADAR REFLECTORS

(71) Applicant: Elwha LLC, Bellevue, WA (US)

(72) Inventors: Tom Driscoll, San Diego, CA (US); Roderick A. Hyde, Redmond, WA (US); Jordin T. Kare, Seattle, WA (US); David R. Smith, Durham, NC (US); Clarence T. Tegreene, Mercer Island, WA (US)

(21) Appl. No.: 14/011,275

(22) Filed: Aug. 27, 2013

Related U.S. Application Data
(63) Continuation-in-part of application No. 13/950,719, filed on Jul. 25, 2013.

(51) Int. Cl. G01S 13/74; H01Q 15/14

(52) U.S. Cl. CPC G01S 13/74; H01Q 15/14
USPC 342/6; 342/5; 342/51

(57) ABSTRACT

A wearable radar reflector includes a retroreflector configured to reflect radiation received from a vehicle, and incorporated into a garment worn by a pedestrian.

If an Application Data Sheet (ADS) has been filed on the filing date of this application, it is incorporated by reference herein. Any applications claimed on the ADS for priority under 35 U.S.C. §§119, 120, 121, or 365(c), and any and all parent, grandparent, great-grandparent, etc. applications of such applications, are also incorporated by reference, including any priority claims made in those applications and any material incorporated by reference, to the extent such subject matter is not inconsistent herewith.

### CROSS-REFERENCE TO RELATED APPLICATIONS

The present application claims the benefit of the earliest available effective filing date(s) from the following listed application(s) (the “Priority Applications”), if any, listed below (e.g., claims earliest available priority dates for other than provisional patent applications or claims benefits under 35 USC §119(e) for provisional patent applications, for any and all parent, grandparent, great-grandparent, etc. applications of the Priority Application(s)). In addition, the present application is related to the “Related Applications,” if any, listed below.

### PRIORITY APPLICATIONS

The present application constitutes a continuation-in-part of U.S. patent application Ser. No. 13/950,719, entitled WEARABLE RADAR REFLECTORS, naming TOM DRISCOLL, RODERICK A. HYDE, JORDINT T. KARE, DAVID R. SMITH, AND CLARENCE T. TEGREENE as inventors, filed 25 Jul. 2013 with attorney docket no. 0513-035-001-000000, which is currently co-pending or is an application of which a currently co-pending application is entitled to the benefit of the filing date.

### RELATED APPLICATIONS

None.

If the listings of applications provided above are inconsistent with the listings provided via an ADS, it is the intent of the Applicant to claim priority to each application that appears in the Priority Applications section of the ADS and to each application that appears in the Priority Applications section of this application.

All subject matter of the Priority Applications and the Related Applications and of any and all parent, grandparent, great-grandparent, etc. applications of the Priority Applications and the Related Applications, including any priority claims, is incorporated herein by reference to the extent such subject matter is not inconsistent herewith.

### SUMMARY

In one aspect, a wearable radar retroreflector includes a retroreflector (e.g., a corner cube, a composite corner cube, or a Van Atta array) configured to reflect radiation having a frequency of about 1 to about 300 GHz (e.g., about 70-85 GHz), and a garment configured to be worn by a pedestrian, wherein the retroreflector is attached to the garment and configured to retroreflect an information signal from a vehicle. The retroreflector may be configured to passively reflect the information signal or to boost its power. The retroreflector may receive the information signal and emit a response signal, which may include identifying information for the pedestrian (e.g., position or demographics). The response signal may be encoded, for example, by a spatial dependence of the retroreflection or by vibration of the retroreflector, and may be emitted in response to a characteristic of the information signal (e.g., signal strength, signal frequency, or signal content). The retroreflector may be powered, and may be configured to use power only under a predetermined condition (e.g., time of day, date, location, or user status). The wearable radar retroreflector may include an accelerometer, which may be configured to record or report movement data of the retroreflector in response to receiving an information signal. The retroreflector may be configured to control the angular divergence of the retroreflected signal, and may have a frequency-dependent response. The wearable radar retroreflector may include a second retroreflector attached to the garment.

In another aspect, a method of preventing collisions includes receiving a radar signal having a frequency of about 1 to about 300 GHz (e.g., about 70-85 GHz) at a pedestrian location from a radar source, and retroreflecting the radar signal toward the radar source (e.g., with a corner cube, a composite corner cube, or a Van Atta array), the retroreflection indicating information about the position of a pedestrian at the pedestrian location. The method may include reflecting the radar signal with a passive retroreflector or boosting the power of the reflected signal. The method may include transmitting a response signal, which may be encoded (e.g., by a spatial dependence of the retroreflection or by vibrating the retroreflector). The response signal may include identifying or demographic information about the pedestrian. Retroreflecting the radar signal may include retroreflecting the radar signal in response to a characteristic of the radar signal (e.g., signal strength, signal frequency, or signal content). The method may further include storing or reporting movement data for the pedestrian (e.g., in response to receiving the radar signal). Retroreflecting the radar signal may include controlling the angular divergence of the retroreflected radar signal.

In yet another aspect, a method of preventing collisions includes sending a radar signal having a frequency of about 1 to about 300 GHz (e.g., about 70-85 GHz) from an operating vehicle, receiving a retroreflected response radar signal (e.g., with a corner cube, a composite corner cube, or a Van Atta array) from a pedestrian in response to the sent signal, and taking action to prevent the operating vehicle from striking the pedestrian or to mitigate the effect of striking the pedestrian (e.g., by braking, changing direction, deploying a collision mitigation device such as an extendable bumper, an internal airbag, or an external airbag, or interpreting data from the retroreflected response radar signal to select an action). Receiving the retroreflected response radar signal may include receiving a passively retroreflected signal or a boosted radar signal. The method may include receiving a second retroreflected response radar signal from a second pedestrian or from a detected vehicle, in which case taking action may include avoiding both or prioritizing which to strike.

In still another aspect, a radar identification device includes a memory configured to store demographic information for a user, and a radar retroreflector (e.g., a Van Atta retroreflector) configured to be worn or carried by the user and further configured to modulate a retroreflected signal in the frequency range of about 1 to about 300 GHz (e.g., about 50 to about 100 GHz, or about 70 to about 85 GHz) with at least a subset of the stored demographic information. The memory may be configured to update the stored demographic information, and may be configured to be worn or carried by the user. The radar retroreflector may be configured to select what demographic information to include in the modulated retroreflected radar signal. It may be a first radar retroreflector, and the device may include a second radar retroreflector, which may produce the same or a different retroreflected radar signal. The radar retroreflector may be configured to modulate the retroreflected signal ultrasonically. The demographic information may include species (e.g., a dog, a cat, or another pet), age (e.g., a child or an elderly person), sex, or physical capabilities (e.g., maximum walking speed). The demographic information may include its leash status (e.g., leashed, unleashed, on a retractable leash, or a leash length).

In a further aspect, a wearable radar identification system includes an identification structure having a defined radar identification signature for radar in the frequency range of about 1 to about 300 GHz (e.g., about 50 to about 100 GHz, or about 70 to about 85 GHz), the signature being associated with demographic information for an associated user, and a garment incorporating the identification structure, configured to be worn by the associated user. For example, the identification structure may include an array of retroreflectors (which may have positions that encode the demographic information), or the identification structure may include a modulated retroreflector (e.g., one configured to modulate the retroreflected signal ultrasonically, or a modulated Van Atta array), or the identification structure may include a radar beacon (e.g., a radar-triggered radar beacon), or the identification structure may include a radar reflector. The demographic information may include species (e.g., a dog, a cat, or another pet), age (e.g., a child or an elderly person), sex, or physical capabilities (e.g., maximum walking speed). The demographic information may include its leash status (e.g., leashed, unleashed, on a retractable leash, or a leash length).

In a still further aspect, a method of preventing collisions includes receiving a radar signal having a frequency of about 1 to about 300 GHz (e.g., about 50 to about 100 GHz, or about 70 to about 85 GHz) at a pedestrian location from a radar source, and transmitting a response signal toward the radar source (e.g., in response to receiving the radar signal), where the response signal includes demographic information about the pedestrian, and is automatically sent without action by the pedestrian. Transmitting the response signal may include retroreflecting the radar signal back toward the radar source with encoded demographic information about the pedestrian (e.g., with a modulated retroreflected signal, or by encoding the information via the positions of the array of retroreflectors), using a radar beacon, or reflecting the radar signal with a radar reflector. The demographic information may include species (e.g., a dog, a cat, or another pet), age (e.g., a child or an elderly person), sex, or physical capabilities (e.g., maximum walking speed). The demographic information may include its leash status (e.g., leashed, unleashed, on a retractable leash, or a leash length), or companions (e.g., whether a child is accompanied by an adult). The response signal may be transmitted only if the pedestrian is near a roadway (e.g., within a predetermined distance such as a user-determined distance) or otherwise in response to a position of the pedestrian.

In yet still a further aspect, a method of preventing collisions includes sending a radar signal from an operating vehicle, receiving a response signal (e.g., a retroreflected response signal) including demographic information about a pedestrian in response, and taking action to prevent the operating vehicle from striking the pedestrian or to mitigate the effect of striking the pedestrian. Taking action may include taking action in response to the demographic information. The demographic information may include species (e.g., a dog, a cat, or another pet), age (e.g., a child or an elderly person), sex, or physical capabilities (e.g., maximum walking speed). The demographic information may include its leash status (e.g., leashed, unleashed, on a retractable leash, or a leash length).

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

FIG. 1 is a schematic of a retroreflector for use on a pet.

FIG. 2 is a schematic of a retroreflector for use on a child.

FIG. 3 is a schematic of an amplified Van Atta array.

FIG. 4 is a schematic of an array of retroreflectors.

FIG. 5 is a schematic of a powered Van Atta array for attachment to a pedestrian.

FIG. 6 is a flow chart showing operation of a retroreflector for collision avoidance.

FIG. 7 is a flow chart showing the method of preventing collisions from the vehicle side.

FIG. 8 is a schematic of a radar-triggered radar beacon.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

“Retroreflector,” as that term is used herein, includes “passive” retroreflectors that reflect a signal back in the direction from which it came (e.g., a corner cube or a Van Atta array), and also “active” retroreflectors which boost or filter a received signal or send a modulated response signal back in the direction from which a signal was received (e.g., a Van Atta array including switches for modulation of the retroreflection, as described in Thornton, et al., “Modulating retro-reflector as a passive radar transponder,” Elect. Lett. (September 1998) 34(19):1880-1881, which is incorporated by reference herein).

“Garment,” as that term is used herein, includes clothing, apparel, or jewelry such as but not limited to shirts, coats, pants, shoes, hats, collars, bracelets, earrings, belts, or backpacks, and also objects designed to be carried by pedestrians, such as but not limited to briefcases, purses, suitcases, keyfobs, cellphones, or tablets.

“Pedestrian,” as that term is used herein, includes a human or pet that is not currently in a vehicle. Pedestrians may include adults, children, dogs, cats, livestock, or other animals, and may include not only walkers, but bicyclists, wagon riders, or other users of open, unpowered vehicles such as those typically found on sidewalks. “Demographics” of a pedestrian may include species, age, sex, physical capabilities, or other relevant information about the pedestrian. “Identifying information” of a pedestrian may include information such as name, address, guardian, next-of-kin, owner, or the like.

Cars and trucks are increasingly being outfitted with technological systems for collision avoidance. In particular, cars and trucks are beginning to include radar systems, primarily for detecting other vehicles for collision avoidance or for convoying. Radar retroreflectors may be detected by such systems and therefore may be used to “mark” the locations of pedestrians to avoid collisions (for example, children or pets, who may be less aware of vehicles in their vicinity than adults).

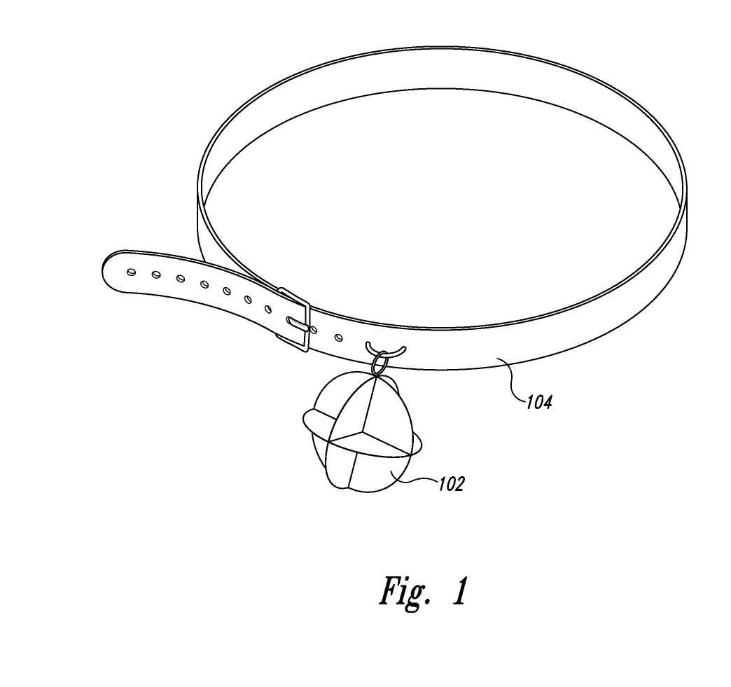

FIG. 1 shows a simple corner cube configured for attachment to a pet. The corner cube 102 is attached to a collar 104, which may be any conventional collar and may include standard safety features such as a breakaway attachment to prevent strangulation if the collar catches on a branch or the like. Current vehicle radar systems typically use frequencies of around 75-80 GHz, corresponding to a full wavelength of about 4 mm; a corner cube having a longest dimension of a centimeter or two is adequately reflective for these frequencies. Conventional corner cubes feature three intersecting orthogonal planes, and hence one octant of angular space, i.e., 90° in longitude and latitude. Accordingly, in order to properly retroreflect a radar beam, they must be oriented toward the incident beam such that it arrives within their acceptance angle. For some embodiments, the orientation of the pedestrian's garment towards a vehicular radar beam may not be such that a simple corner cube mounted on it will be adequately pointed towards the beam. To address this issue, composite corner cubes may be used, comprising multiple coattached corner cubes facing in different directions. For instance, a composite corner cube may feature 2 back-to-back cornercubes spanning 180 degrees in one direction, or 4 cornercubes filling a hemispherical solid angle. Composite corner cubes having eight back-to-back corner cubes, such as described by Xian Jin in “Integrated Optical Devices for Free-Space Optical Communications”, Master of Applied Science Thesis, University of British Columbia, 2009, can be used to provide retroreflection for all orientations or beam directions.

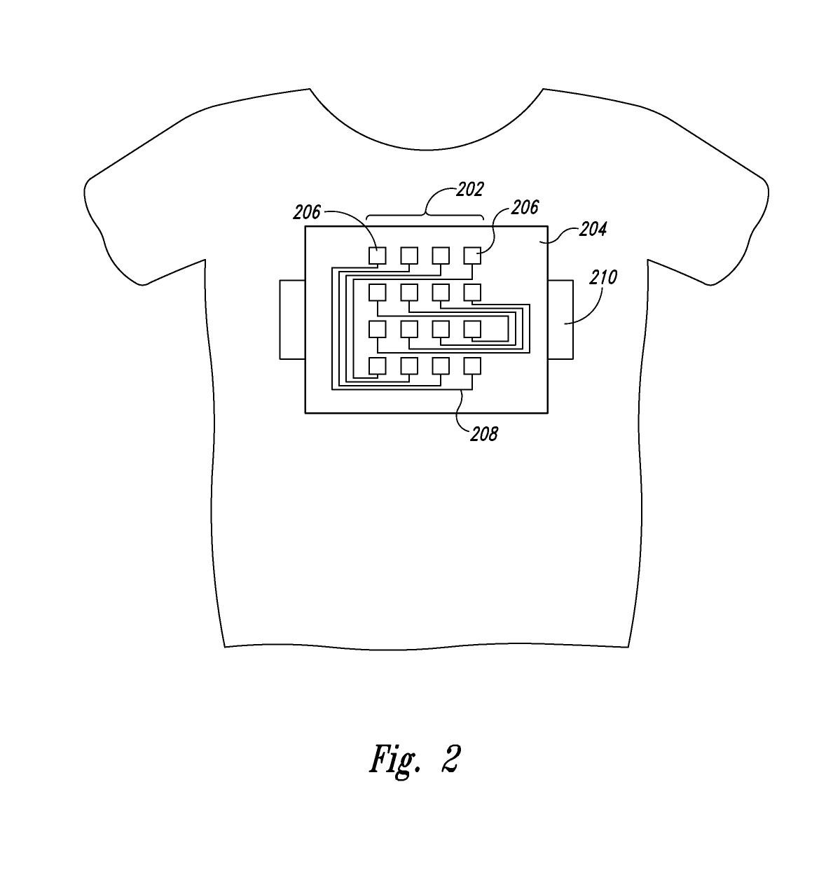

FIG. 2 shows a Van Atta array incorporated into a child's shirt. It will be understood that the array may be smaller or larger than the illustrated embodiment, which is of a size selected to show an appropriate level of detail. The array 202 may be placed, for example, on a circuit board 204 or the like, with apertures 206 on the front of the board and connecting transmission lines 208 placed on the back of the board to form the array. Transmission lines 208 may be implemented as striplines, microstrips, waveguides, coax, wires, or any other transmission line technology commensurate with the incident radar frequency. (Transmission lines 208 all have the same length to achieve retroreflection.) Transmission lines 208 may be designed for broadband frequency response, for example to accommodate a wide range of vehicular radar frequencies. Alternatively, transmission lines 208 may be designed to only operate over a limited band of frequencies, either due to the passive frequency response of the transmission line or attached external filters, or via situationally switching in or out external filters.

Board 204 is attached to the shirt so that it retroreflects whenever the child is in radar range of a vehicle. Outer clothing generally will allow RF radiation to pass with minimal scattering, so that the board has its retroreflective effect even if the child dons a coat or sweater over the array. The array may be configured to control the angular divergence of the retroreflected signal.

In some embodiments, the retroreflector 202 may modulate the retroreflection in order to send a response signal encoding additional additional information such as the identity, demographics, or position of the pedestrian, or to more clearly mark the reflection as coming from a pedestrian. In some embodiments, the modulation may be applied by vibrating the surface of the retroreflector (e.g., corner cube, Van Atta Array), as disclosed for optical corner cubes in U.S. Pat. No. 5,909,279. In some embodiments, the modulation can be introduced electronically (e.g., injected into the transmission lines of a Van Atta Array) as described in Thornton, et al. In some embodiments, the modulation may be selected in response to a characteristic of the incoming signal, for example its strength, frequency, or information content. As examples, the strength of an incident radar signal may indicate that the radar source is relatively close, the frequency of the radar signal may indicate that it is used for parking purposes rather than for collision avoidance purposes, or the incident radar signal may be encoded with a query as to the type of target it is hitting.

As mentioned above, in some embodiments, retroreflector 202 may be configured to modulate the retroreflection, thereby sending information back to the radar emitter. This information may include, for example, demographic or identifying information about the pedestrian. In some embodiments, it may further include information such as the identity or demographics of other pedestrians, which may be used by the radar source to assess risk. For example, a child accompanied by a parent may be considered less likely to run into the street, while a child accompanied only by his peers may be even more likely to behave unpredictably than a child alone. Similarly, a leashed pet is unlikely to be permitted to dart in front of a car. Demographic information may include, for example, a characteristic or a maximum walking speed, which may be used to assess whether a pedestrian is capable of getting out of the way of the vehicle.

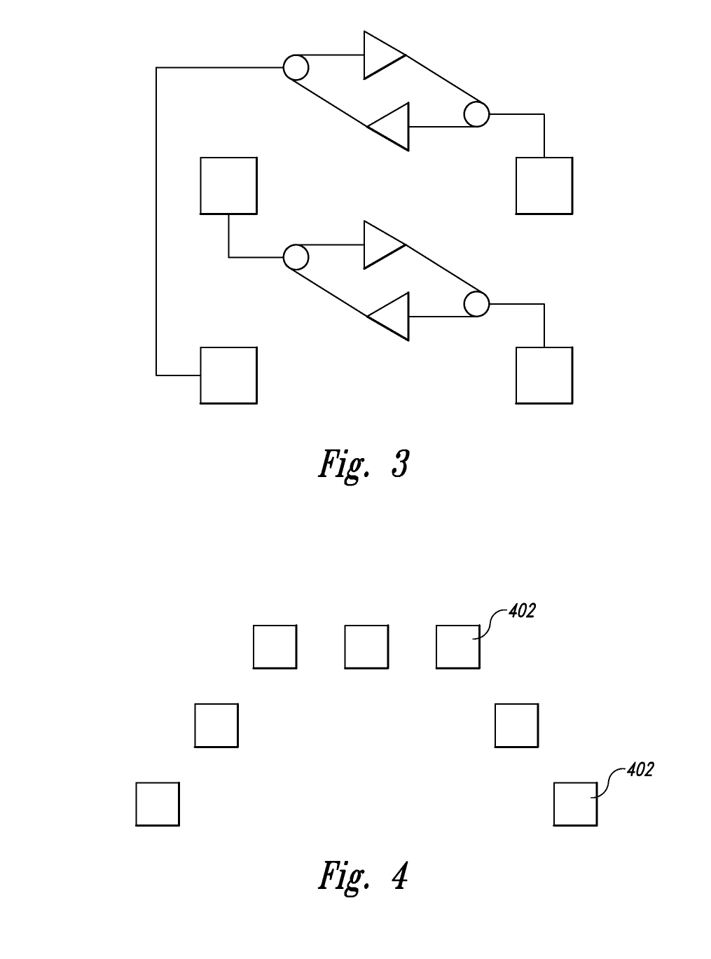

FIG. 3 shows a Van Atta array similar to the one illustrated in FIG. 2, but with amplifiers placed to boost the retroreflected signal. The array of FIG. 3 includes four apertures 302, with each pair connected by two amplifiers 304 and two circulators 306, in the arrangement shown by Bird, RTO-MP-SCI-145 (April 2004), which is incorporated by reference herein. It will be understood that amplifiers 304 and/or circulators 306 are powered to increase the retroreflection. In another embodiment, a steerable antenna such as those described in U.S. Patent Application Publication No. 2012/0194399 (which is incorporated by reference herein, including all matter incorporated by reference into that publication) can be used as a retroreflector. Such an antenna may reflect a signal, or may absorb it and reemit a signal in the direction from which it was received. The reflected or reemitted signal may be selected in response to a characteristic of the incoming signal, for example its strength, frequency, or information content.

FIG. 4 shows an array of retroreflectors 402. The illustrated array is of Van Atta reflectors like that shown in FIG. 2, but corner cubes, steerable antennas, or other retroreflectors may also be used. The placement of retroreflectors within the array may create a characteristic spatial pattern at the radar receiver that identifies the wearer generally as a pedestrian, or with more specific demographic information (e.g., that the wearer is a child, an elderly person, a dog, or a cat).

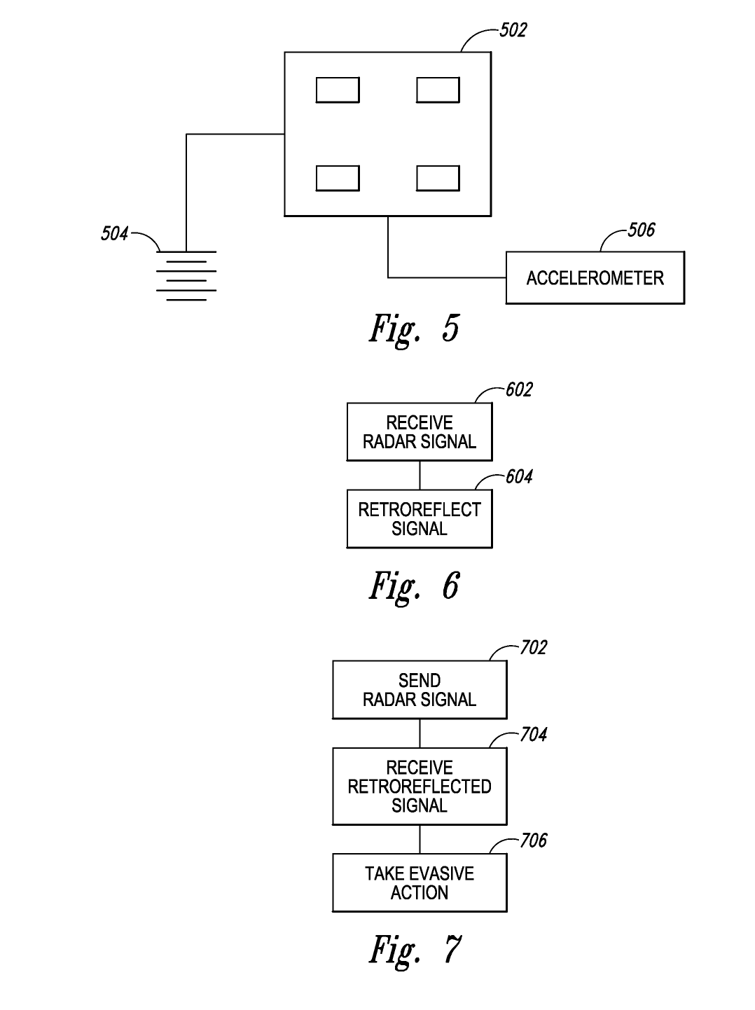

FIG. 5 shows a Van Atta Array 502 connected to a power source 504. The assembly may be connected to a collar of a pet, as a zipper pull on a child, or placed in a purse, briefcase, backpack, or pocket. Array 502 may retroreflect even without being powered, but sends a stronger signal when power is used. To preserve battery life, array 502 is configured to draw power only under certain conditions. Alternatively, the retroreflection can be situationally controlled (even for non-power-boosted arrays) by incorporating switches in the inter-element transmission lines of Van Atta array 502, as described in Thornton, et al. For example, an array 502 may engage when a pet is released from a leash, when a wearer is in proximity to a street, during specified times of day (e.g., after school on school days, and all day on weekends), or combinations of such conditions (e.g., outside of school hours when the user is near a street). Situational control can enhance the pedestrian's privacy (so he is only tracked when at risk from traffic) as well as to limit the number of retroreflecting signals a vehicle's radar must handle to those which are traffic-relevant. In some embodiments, array 502 may be connected to an accelerometer 506 to record movement of the pedestrian. For example, accelerometer 506 may continuously monitor acceleration, and save the last few minutes of data after a rapid acceleration of the pedestrian indicates an impact, or when a signal is received indicating that a radar source is nearby. Recorded movement data can be reported to authorities or to insurance personnel (e.g., after a collision), or to the radar source (e.g., by encoding the retroreflection).

FIG. 6 is a flow chart showing how any of the previously described retroreflectors may be used. The method includes receiving 602 a radar signal having a frequency in the range of about 1 to about 300 GHz (e.g., about 70 to about 85 GHz) at a pedestrian location, and retroreflecting 604 the radar signal toward the radar source, where the retroreflection provides information to the radar source about a position of the pedestrian. The retroreflection may also provide other information as described above, such as the demographics of the pedestrian, which may be used by a vehicular radar source as described below.

FIG. 7 is a flow chart showing how a vehicle may use the retroreflected signals described above to prevent or mitigate collisions. The method includes sending 702 a radar signal from an operating vehicle (e.g., a signal in the range of about 1 to about 300 GHz, or in the range of about 75 to about 80 GHz), receiving 704 a retroreflected signal from the pedestrian in response, and taking action 706 to prevent the vehicle from striking the pedestrian or to mitigate the effects of striking the pedestrian (e.g., if the signal is received too late to avoid a collision entirely). Actions 706 that may be taken include but are not limited to braking the vehicle or changing direction of the vehicle. In some embodiments, the vehicle may include logic circuits configured to interpret data from the retroreflection (e.g., demographic information or movement history) in order to choose a course of action. These logic circuits may be configured to further interpret signals received from a second location (e.g., retroreflected signals from a second pedestrian). Such circuits may be configured to prioritize which source should be struck, if a collision cannot be prevented entirely (e.g., to hit a dog instead of a child). The circuits may be customizable by a user. For example, those most concerned with loss of life may prefer to hit another vehicle (presumably equipped with seat belts and other safety equipment) instead of a dog, while those most concerned with monetary costs may prefer to hit the dog and avoid the other vehicle. In either case, of course, the effects of the collision may be mitigated by braking, steering to strike a glancing blow, deploying collision mitigation devices such as airbags or extendable bumpers, steering to hit a bumper instead of a more vulnerable part of the car, etc. Other user-customizable features may include whether to warn a driver or to simply override his control of a car, for example depending on how close the pedestrian is and how much time is available to avoid the collision.

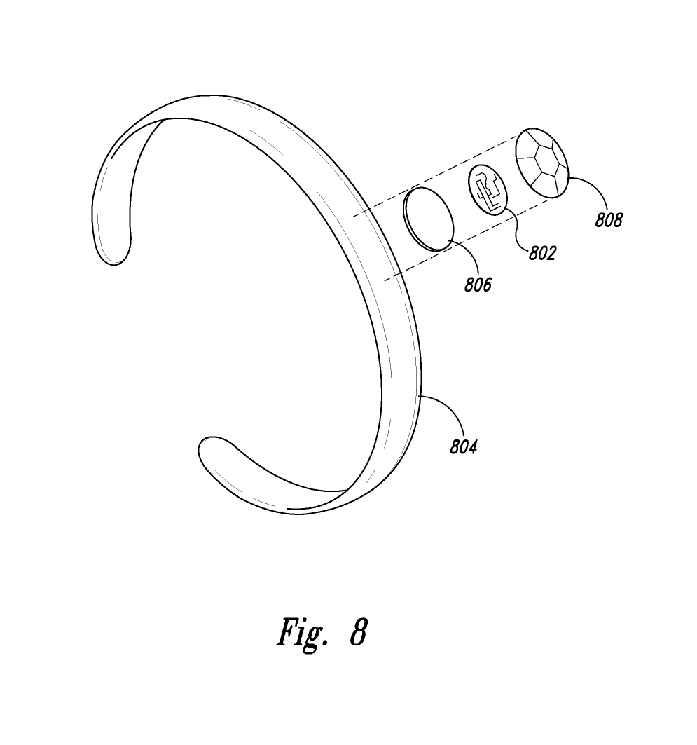

FIG. 8 shows in exploded view a radar beacon 802 incorporated into a bracelet 804. Illustrated beacon 802 is powered by power source 806, which in some embodiments may be switchable as described above to be active only under certain conditions (e.g., when the wearer is at risk due to traffic). The illustrated beacon 802 is covered by a decorative bezel 808 so that it appears simply to be a bracelet. In such embodiments, this type of design may increase user acceptance when the beacon is to be worn by a child.

Various embodiments of retroreflector devices and methods have been described herein. In general, features that have been described in connection with one particular embodiment may be used in other embodiments, unless context dictates otherwise. For example, the corner cubes described in connection with FIG. 1 may be employed in the devices described in connection with FIG. 4, or with any of the embodiments described herein. For the sake of brevity, descriptions of such features have not been repeated, but will be understood to be included in the different aspects and embodiments described herein.

All of the aforementioned U.S. patents, U.S. patent application publications, U.S. patent applications, foreign patents, foreign patent applications and non-patent publications referred to in this specification, or listed in any Application Data Sheet, are incorporated herein by reference, to the extent not inconsistent herewith. This incorporation by reference specifically includes any materials that are incorporated by reference into the aforementioned U.S. patents, U.S. patent application publications, U.S. patent applications, foreign patents, foreign patent applications and non-patent publications.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A radar identification device, comprising:
a memory configured to store demographic information for a user; and
a radar retroreflector, configured to be worn or carried by the user and further configured to modulate a retroreflected radar signal in the frequency range of about 1 to about 300 GHz with at least a subset of the stored demographic information.

2. The device of claim 1, wherein the memory is configured to update the stored demographic information.

3. The device of claim 1, wherein the memory is configured to be worn or carried by the user.

4. The device of claim 1, wherein the radar retroreflector is configured to select what demographic information to include in the modulated retroreflected radar signal.

5. The device of claim 1, wherein the radar retroreflector is a first radar retroreflector, the device further comprising a second radar retroreflector configured to be worn or carried by the user.

6. The device of claim 5, wherein the first radar retroreflector and the second radar retroreflector are configured to produce the same modulated retroreflected radar signal.

7. The device of claim 5, wherein the first radar retroreflector and the second radar retroreflector are configured to produce differing modulated retroreflected radar signals.

8. The device of claim 1, wherein the radar retroreflector is configured to modulate the retroreflected signal ultrasonically.

9. The device of claim 1, wherein the radar retroreflector includes a Van Atta retroreflector.

10. The device of claim 1, wherein the demographic information includes at least on item selected from the list consisting of species, age, sex, and physical capabilities.

11. The device of claim 1, wherein the demographic information includes that the user is a child.

12. The device of claim 1, wherein the demographic information includes that the user is elderly.

13. The device of claim 1, wherein the demographic information includes a maximum walking speed for the user.

14. The device of claim 1, wherein the demographic information includes that the user is a pet.

15. The device of claim 14, wherein the demographic information further includes the leash status of the pet.

16. The device of claim 1, wherein the retroreflected radar signal is in the frequency range of about 50 to about 100 GHz.

17. The device of claim 1, wherein the retroreflected radar signal is in the frequency range of in the frequency range of about 70 to about 85 GHz.

18. A wearable radar identification system, comprising:
an identification structure having a defined radar identification signature for radar in the frequency range of about 1 to about 300 GHz, the signature being associated with demographic information for an associated user; and
a garment incorporating the identification structure, configured to be worn by the associated user.

19. The system of claim 18, wherein the identification structure includes an array of retroreflectors.

20. The system of claim 19, wherein the retroreflectors of the array have positions that encode the demographic information.

21. The system of claim 18, wherein the identification structure includes a modulated retroreflector.

22. The system of claim 21, wherein the modulated retroreflector is configured to modulate the retroreflected signal ultrasonically.

23. The system of claim 21, wherein the modulated retroreflector includes a modulated Van Atta array.

24. The system of claim 18, wherein the identification structure includes a radar beacon.

25. The system of claim 24, wherein the radar beacon is radar triggered.

26. The system of claim 18, wherein the identification structure includes a radar reflector.

27. The system of claim 18, wherein the demographic information includes at least one item selected from the group consisting of species, age, sex, and physical capabilities.

28. The system of claim 18, wherein the demographic information includes that the associated user is a child.

29. The system of claim 18, wherein the demographic information includes that the associated user is elderly.

30. The system of claim 18, wherein the demographic information includes a maximum walking speed for the user.

31. The system of claim 18, wherein the demographic information includes that the associated user is a pet.

32. The system of claim 31, wherein the demographic information further includes the leash status of the pet.

33. The system of claim 18, wherein the identification structure has a defined radar identification signature for radar in the frequency range of about 50 to about 100 GHz.

34. The system of claim 18, wherein the identification structure has a defined radar identification signature for radar in the frequency range of about 70 to about 85 GHz.

35. A method of preventing collisions, comprising:
receiving a radar signal having a frequency of about 1 to about 300 GHz at a pedestrian location from a radar source; and
transmitting a response signal toward the radar source, wherein the response signal includes demographic information about the pedestrian, and wherein the response signal is sent without action by the pedestrian.

36.-52. (canceled)

53. A method of preventing collisions, comprising:
sending a radar signal from an operating vehicle;
receiving a response signal from a pedestrian in response to the sent signal, the response signal including demographic information about the pedestrian; and
taking action to prevent the operating vehicle from striking the pedestrian or to mitigate the effect of striking the pedestrian.

54.-61. (canceled)
